(19) United States
(12) Patent Application Publication
(10) Pub. No.: US 2008/0167589 A1
(43) Pub. Date: Jul. 10, 2008

(54) FOOT MASSAGING APPARATUS

(76) Inventor: KAM FAI FUNG, Tuen Mun (HK)

Correspondence Address: Lawrence Cruz;Conair Corporation, One Cummings Point Road, STAMFORD, CT, 06902, US

(21) Appl. No.: 11/969,450

(22) Filed: Jan. 4, 2008

Related U.S. Application Data
(60) Provisional application No. 60/879,282, filed on Jan. 5, 2007.

(51) Int. Cl. A61H 23/00

(52) U.S. Cl. 601/104; 601/46; 601/107

(57) ABSTRACT

A foot massager apparatus (10) includes a flexible membrane (16) that transmits percussive forces to the water above the membrane (16) to provide massaging, percussive water wave effects, audio speakers (100), mp3 player capability (106), and voice data input capability.

### REFERENCE TO RELATED APPLICATIONS

This application is related to and claims priority from U.S. Provisional Application No. 60/879,282, filed on Jan. 5, 2007.

### BACKGROUND

1. Technical Field

The present disclosure relates to personal care appliances and, more particularly, to a foot bath and/or a massaging apparatus.

2. Description of the Related Art

Various foot baths exist with a varying degree of single or multiple functions for providing vibrating massage sensations to a user's feet. Some devices include a water basin for receiving the user's feet and a pump to move water within the basin thereby creating a therapeutic current effect. A heater may be incorporated within the bath to heat the user's feet. Generally, a common objective in the foot baths is to provide relief to a user by providing soothing, therapeutic stimuli to the user's feet.

### SUMMARY

Accordingly, the present disclosure is directed to further improvements in foot bath or foot massager apparatii. In one embodiment, a therapeutic apparatus includes a housing defining a chamber therein adapted to receive a user's feet, a flexible membrane disposed within the chamber and a drive member associated within the flexible membrane for providing one of vibrating, percussive, repetitive or oscillating movement to the flexible membrane to provide a therapeutic effect on the user's feet. A motor may be mounted within the housing and operatively coupled to the drive member. The motor is actuable to move the drive member to effect corresponding movement of the flexible membrane. An eccentric cam may be coupled to the motor and adapted for rotational movement about a drive axis to effect corresponding movement of the flexible membrane. First and second eccentric cams may be coupled to the motor and disposed in spaced relation beneath the flexible membrane. An associated eccentric cam may be operatively coupled to a piston which is in operative engagement with the flexible membrane whereby rotation of the eccentric cam causes the piston to reciprocate to cause corresponding vibration of the membrane. First and second eccentric cams preferably are coupled to the motor and have respective first and second pistons operatively coupled therewith. The pistons are arranged in spaced relation beneath the flexible membrane.

The housing may include at least one audio speaker for transmitting audio signals. An audio input may be in communication with the at least one speaker. The audio input may be adapted for connection to an MP3 audio encoding format. Computer memory means for storing audio data may be incorporated within the housing. Voice input control and associated logic for receiving audio input signals from the user, and for transmitting signals through the at least one speaker and/or for controlling operation of at least the drive member may be provided.

A bubble emitter may be positioned adjacent the flexible membrane for emitting bubbles toward the user's feet. The bubble emitter may be arranged to at least partially circumscribe the flexible membrane. At least one splash guard may be mountable to the body. The at least one splash guard is adapted for sliding movement relative to the body. The at least one splash guard may include one of a loofah pad or massaging roller.

### BRIEF DESCRIPTION OF THE DRAWINGS

Various embodiments of the present disclosure will be better appreciated by reference to the drawings wherein:

FIG. 1A is a top view of a foot massager apparatus in accordance with the principles of the present disclosure;

FIG. 1B is a bottom view of the foot massager apparatus of FIG. 1A;

FIG. 2A is a rear plan view of the foot massager apparatus;

FIG. 2B is a front plan view of the foot massager apparatus;

FIG. 2C is a side view of the foot massager apparatus;

FIG. 3A is a perspective view of the foot massager apparatus illustrating the lid positioned on the body;

FIG. 3B is a perspective view of the foot massager apparatus illustrating the lid removed from the body;

FIGS. 4A-4C are perspective views of the foot massager apparatus illustrating various states of operation of fluid jet and mist emitters;

FIG. 5 is a perspective view illustrating components of the fluid jet and mist mechanism;

FIG. 6 is a partial cross sectional view of the foot massager apparatus illustrating the vibrating membrane mechanism;

FIG. 7 is a perspective view of the foot massager apparatus illustrating components of the vibrating membrane mechanism;

FIGS. 8A-8B are cross sectional views further illustrating internal components of the vibrating membrane mechanism;

FIG. 9 is view illustrating further components of the vibrating membrane mechanism;

FIGS. 10A-10B are top and partial views of the foot massager apparatus illustrating the bubble emitting mechanism;

FIGS. 11A-11B are views of the foot massager apparatus illustrating first and second splash covers with associated accessories;

FIGS. 12A-12C are views of the foot massager apparatus illustrating the sliding splash guard;

FIG. 13A is a top view of the foot massager apparatus illustrating the user's feet positioned within the body in a first position;

FIG. 13B is a top view of the foot massager apparatus illustrating the user's feet positioned within the body in a second position;

FIGS. 14A-14B are perspective views of the foot massager apparatus illustrating handle features;

FIG. 15 is a perspective, partial exploded view of the foot massager apparatus illustrating use with an mp3 player; and

FIG. 16 is a perspective view of the foot massager apparatus illustrating vibration aspects of the present disclosure.

### DETAILED DESCRIPTION OF THE PREFERRED EMBODIMENT(S)

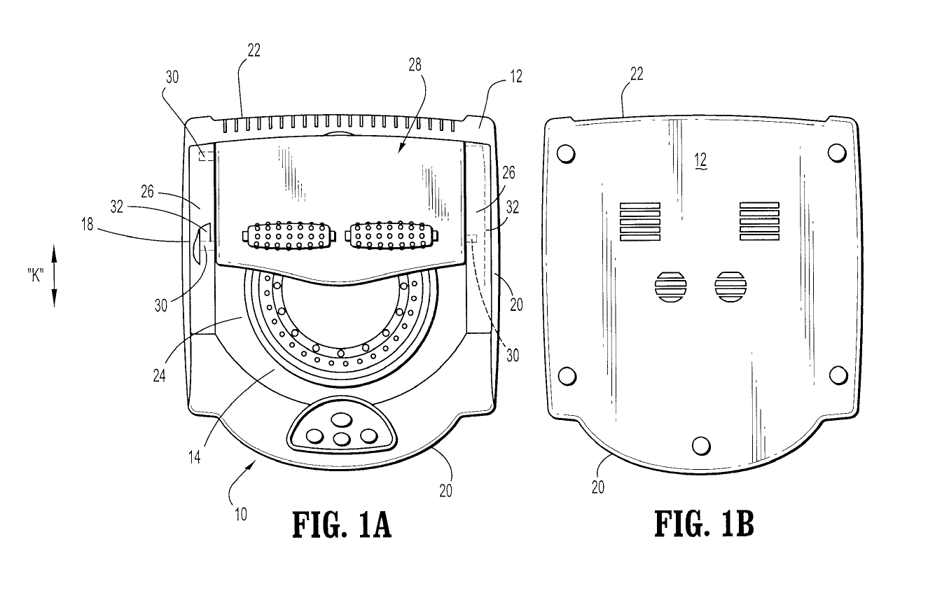

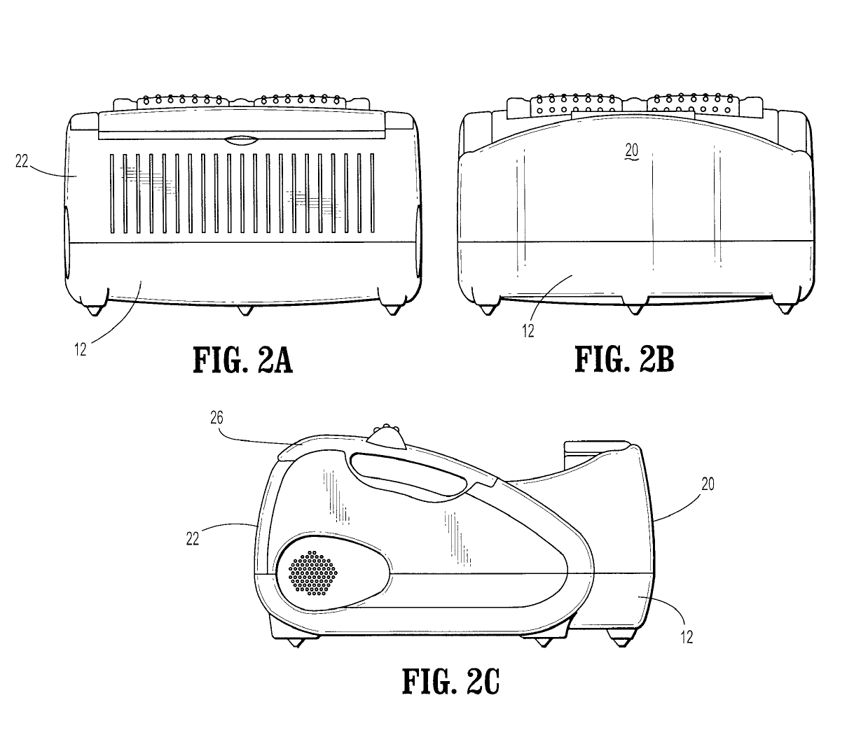

Referring to the drawings wherein like reference numerals identify similar or like components throughout the several views, FIGS. 1A-3B illustrate the foot massager apparatus 10 in accordance with the principles of the present disclosure. Foot massager apparatus 10 includes outer housing 12 and inner basin or body 14 within the outer housing 12. Housing 12 and body 14 includes floor or bottom 16, a pair of side walls 18, and front and rear walls 20, 22, which collectively define, in whole or in part, internal reservoir or chamber 24. Internal chamber 24 is intended to receive a volume of fluid, e.g., water, and one or more of a user's feet to be therapeutically treated or bathed within the internal chamber 24. Housing 12 and body 14 may be manufactured from any suitable metal or polymeric material, and may be readily cleaned after use. Housing 12 further includes upper handles 26 which are arranged in opposed relation adjacent each of side walls 18. Handles 26 are adapted for engagement by the user to assist in moving the apparatus 10 to different locations.

Mounted adjacent or between handles 26 is splash guard or lid 28. Splash guard 28 may be releasably secured to handles 26 by any known means and may be selectively removable from the handles 26 to permit greater access to internal chamber 16. Splash guard 28 also may be slidably mounted to handles 26 to permit the user to selectively move the splash guard 28 to positions between front and rear walls 20, 22. Any means for slidably mounting splash guard 28 to handles 26 are envisioned. For example, in one embodiment, splash guard 28 may have outwardly depending cam pins 30 (FIG. 1A) which are received within corresponding internal slots 32 defined within handles 26. Pins 30 slide within slots 32 (Shown in phantom) to permit reciprocal movement of splash guard 28 relative to body 14 in the direction of directional arrows “k”.

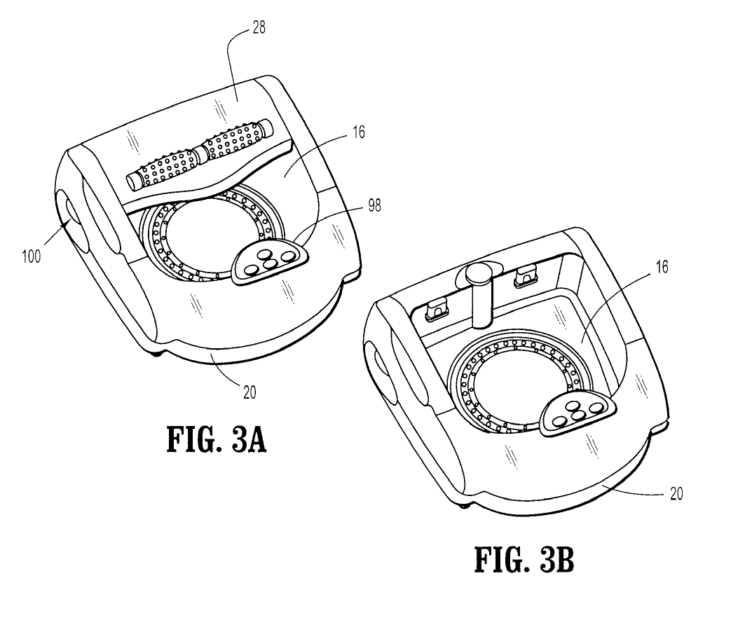

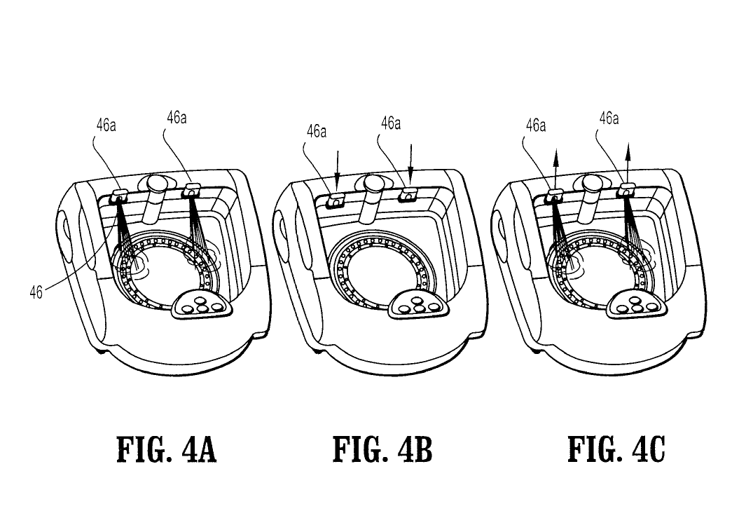

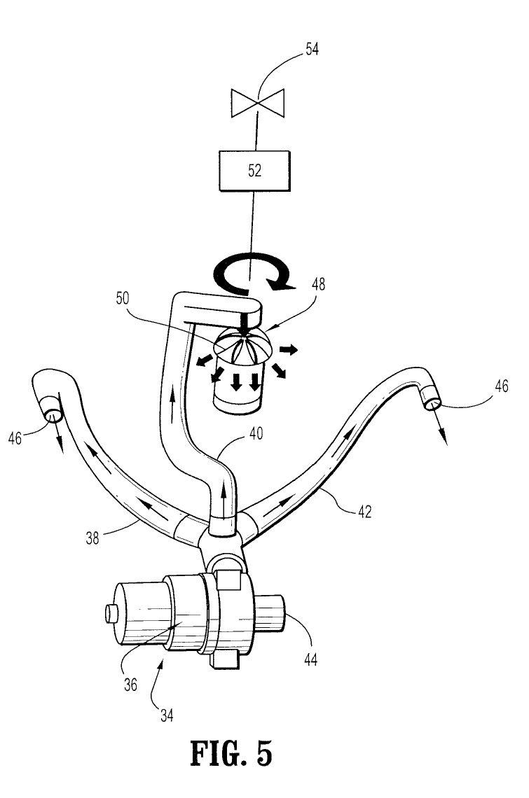

Referring now to FIGS. 4A-5, in conjunction with FIGS. 3A-3B, the fluid jet and mist mechanism 34 of foot massager apparatus 10 will be described. Fluid jet and mist mechanism 34 is adapted to expel fluid under pressure toward the user's feet and, either, concurrently or independently, to deliver a mist within internal chamber 16. Fluid jet and mist mechanism 34 includes fluid pump 36 and first, second and third conduits 38, 40, 42, each of which are in fluid communication with the fluid pump 36. Fluid pump 36 may be any conventional pump appreciated by one skilled in the art and being adapted to deliver the fluid under pressure through first, second and third conduits 38, 40, 42. In one embodiment, fluid pump 36 includes pump inlet 44 to collect fluid, e.g., water, within internal chamber 16, for passage through the pump 36. In the alternative, pump inlet 44 may be connected to an external fluid or water source. Fluid jet and mist mechanism 34 includes jet outlets 46 which are mounted adjacent rear wall 22 and in fluid communication with first and third conduits 38, 42. Jet outlets 46 are arranged to deliver fluid in a general downward direction under pressure to the user's feet positioned within internal chamber 16. Jet outlets 46 may have associated covers 46a which are selectively movable to open and close the openings of the jet outlets 46. Covers 46a may be mounted to splash guard 28 in slidable manner or may be integrally formed with the splash guard 28. Fluid jet and mist mechanism 34 further includes mist generator 48 disposed between jet outlets 46 and in fluid communication with second conduit 40. Mist generator 48 may include mist fan 50 and an associated motor 52 which causes rotation of the fan 50. Mist fan 50 rotates to divide, separate or split the water stream emitted from mist outlet 52 to develop a fine mist within internal chamber 16 and onto the user's feet. Any suitable fan and associated motor may be incorporated within fluid jet and mist mechanism 34 and may be actuated independently through a switch shown schematically as reference numeral 54. First, second and third conduits 38,40,42 may be flexible tubing and may, along with fluid pump 36, be disposed within the internal space defined within outer housing 12.

Fluid jet and mist mechanism 34 may operate in three modes of operation, namely, 1) Water jet only mode—where water jet outlets 46 remain open and mist generator is off; 2) Mist only mode—where the water jet outlets 46 are closed and the mist generator is operating; and 3) Water jet & mist mode-where the jet outlets 46 are opened and the mist generator 48 is operating.

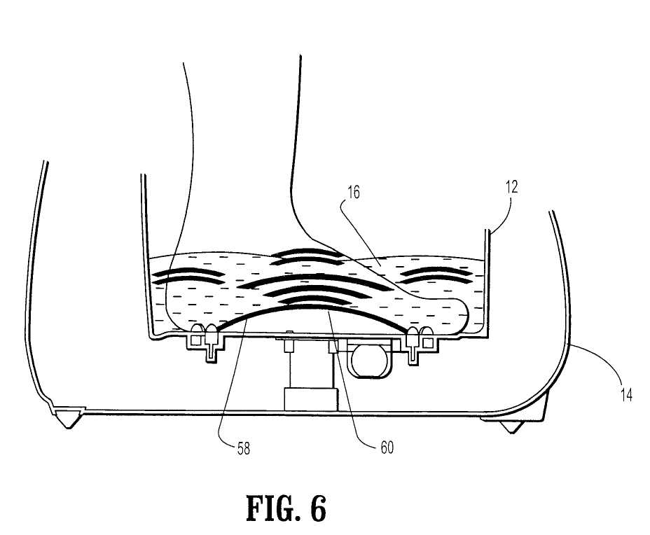

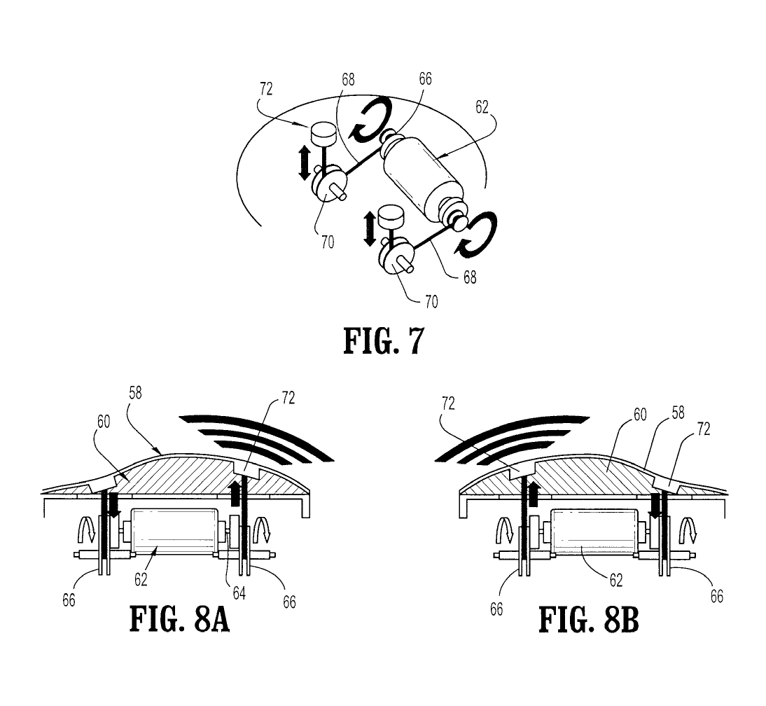

Referring now to FIGS. 6-9, the vibrating membrane mechanism 56 of foot massager apparatus 10 will be described. Vibrating membrane mechanism 56 is adapted to impart a percussive, vibratory or oscillatory force in the direction of the user's feet to provide a stimulating effect on the user's feet. Vibrating membrane mechanism 56 includes flexible membrane 58 mounted within the interior of internal chamber 16, resilient or foam member 60 disposed beneath the flexible membrane 58, motor 62 having central drive shaft 64 and offset eccentric cams 66 mounted on each end of the central drive shaft 64. Flexible membrane 58 may include any resilient or elastomeric material having sufficient flexibility and resiliency to be manipulated and/or stretched. Central drive shaft 64 is adapted to rotate upon actuation of motor 62 to thereby cause corresponding rotation of eccentric cams 66. Vibrating membrane mechanism 56 further includes a pair of transmission members 68 connected to eccentric cams 66, a pair of pulleys 70 adjacent respective cams 66 and associated pistons 72. Pistons 72 are secured to the interior of flexible membrane 58 and may incorporate any relatively rigid disc or cylindrical shaped element adapted to impart pressure to flexible membrane 58 and/or foam member 60. Other configurations are also envisioned. Pulleys 70 may be secured within housing 12 by any conventional means and may incorporate wheels or grooves through or upon which transmission members 68 are wound. Actuation of motor 62 causes drive shaft 64 and eccentric cams 66 to correspondingly rotate, which drives transmission members 68 to move through pulleys 70 thereby imparting reciprocal motion to pistons 72. Pistons 72 reciprocally contact the bottom surface of flexible membrane 58 in an opposed “push/pull manner” causing vibration or percussive waves to resonate through foam member 60, flexible membrane 58 and/or water resting in internal chamber 16 to thereby impart a massaging effect on the user's feet. In the event the user opts to not fill internal chamber 16 with water, flexible membrane 58 is still suitable to impart massaging effects on a user's feet which are in direct contact with the flexible membrane 58.

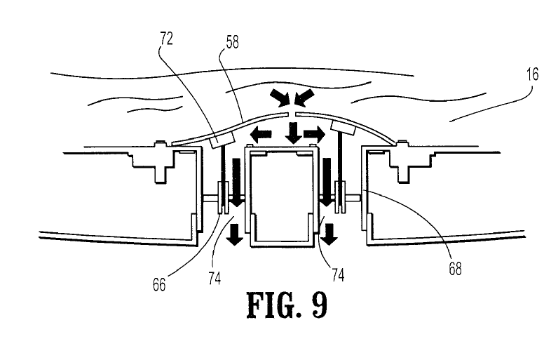

As best depicted in FIG. 9, flexible membrane 58 is disposed on bottom wall of body 14 and is designed to be fluid tight to prevent leakage of fluid. Any means for mounting flexible membrane 58 to bottom wall are envisioned including, but, not limited to, the use of cements, adhesives or the like. First and second drainage channels 74 extend through bottom wall and permit fluid within internal chamber 16 to escape past the components of the vibratory system in the event of a leak within the system due to a tear or rupture in the flexible membrane 58.

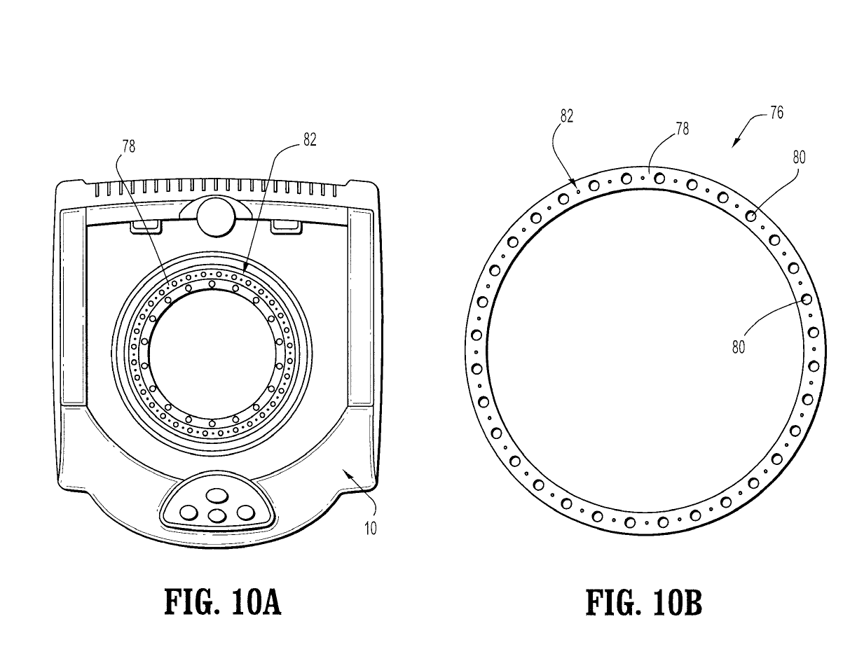

Referring now to FIGS. 10A-10B, the bubble emitting mechanism 76 of foot massager apparatus 10 will be described. Bubble emitting mechanism 76 is intended to emit a plurality of air bubbles within internal chamber 16 for stimulation and/or soothing of the user's feet. Bubble emitting mechanism 76 includes bubble emitter or ring 78 having associated outlets 80 forming a patterned opening for air bubbles to be emitted into water resting in the chamber 16. The pattern of outlets 80 does not necessarily have to be in a ring shaped array. For example, one or more linear rows of holes would suffice. Any one or more of other various configurations, including non-linear arrays, are also contemplated. Ring 78 may at least partially or entirely circumscribe flexible membrane 58 to focus the therapeutic effects of massager 10 within the center of internal chamber 16. Bubble emitting mechanism 76 may include an air pump 82 in fluid communication with outlets 80 to assist in generating the bubbles. Pump 82 shown schematically may be mounted within housing 12.

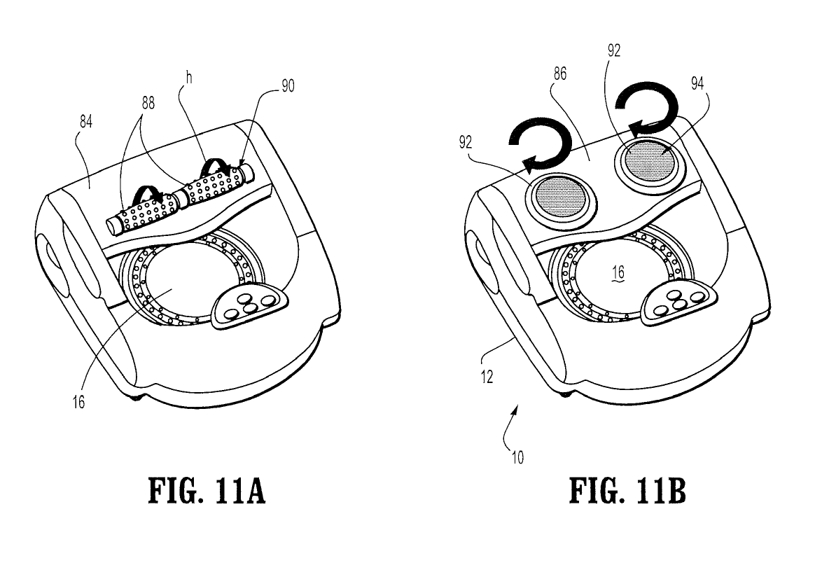

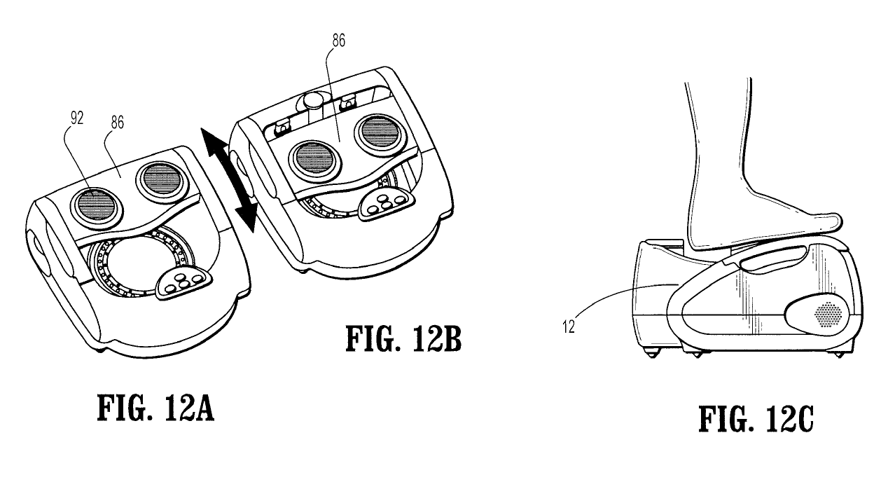

Referring now to FIGS. 11A-11B, the motorized roller/loofah mechanism will be discussed. Foot massager apparatus 10 may include first and second splash guards 84, 86. First splash guard 84 includes rollers 88 which are operated via motor(s) and rotate as indicated by directional arrows “b” to massage the sole area of the user's feet. Motors shown schematically as reference numeral 90 may be incorporated within rollers 88 or mounted adjacent the underside of first splash guard 84. Second splash guard 86 incorporates rotating loofah pads 92 adapted to rotate in the direction of directional arrows “m” to exfoliate or perform pedicure functioning. Loofah pads 92 are rotated via motors shown schematically as reference numeral 94 and may be incorporated with the loofah pads or mounted adjacent the underside of second splash guard 86. In the alternative, rollers 88 or loofah pads 92 may be manually operated or may be stationary. FIGS. 12A-12C illustrate the sliding capability of second splash guard 86 relative to housing 12 as discussed hereinabove. First splash guard 84 may slide in a similar manner.

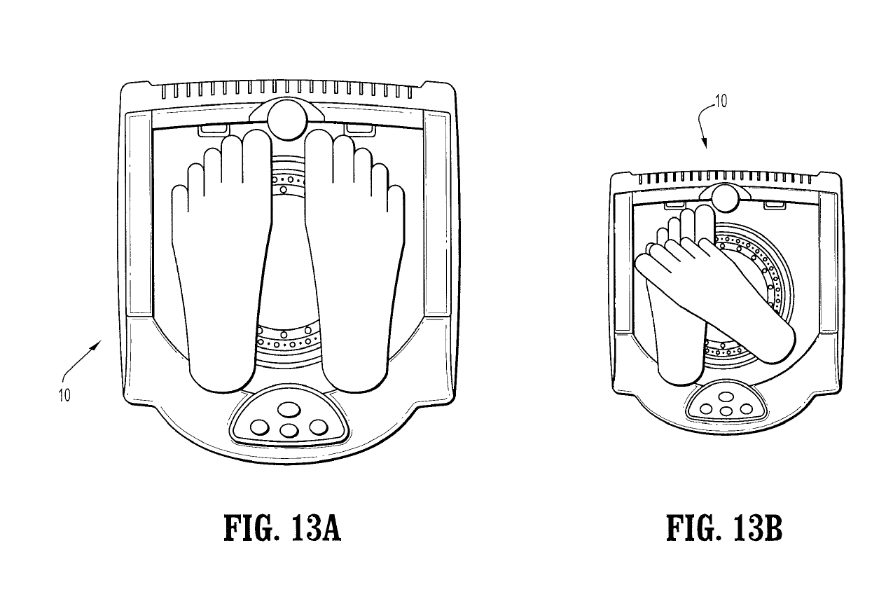

FIGS. 13A-13B illustrate the user's feet within internal chamber 16. As shown, bottom wall including flexible membrane 16 provides a substantially planar profile, i.e., the internal chamber 16 lacks a center “island” or portion that protrudes above the floor of the chamber. This feature permits the user to manipulate his/her feet to various positions, thereby provided maximum comfort. Schematic outlines of a user's feet are provided for illustrative purposes.

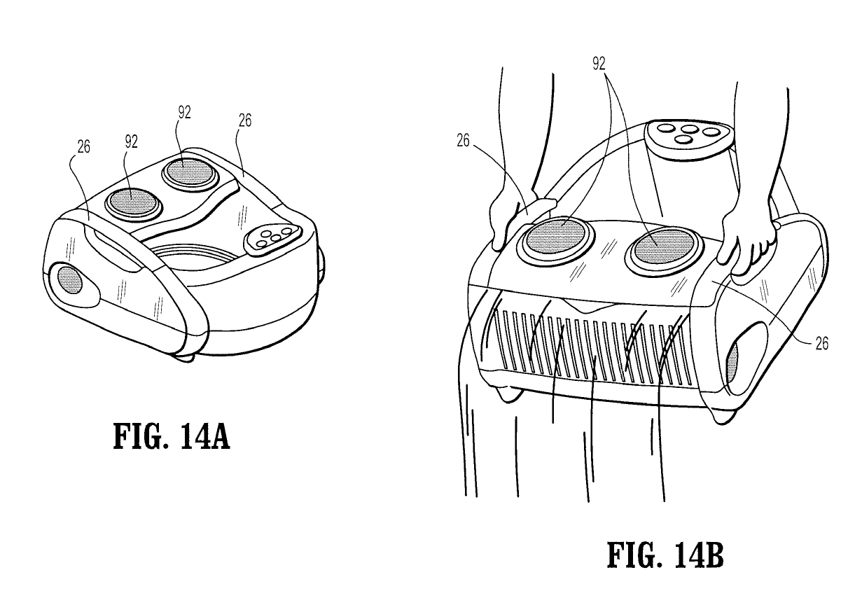

FIGS. 14A-14B illustrate drainage of foot massager apparatus 10. As shown, a gap 96 exists between housing 12 and splash guard 84 to permit fluid to be drained from the internal chamber 16 by tilting of foot massager apparatus 10 via manipulation of handles 26.

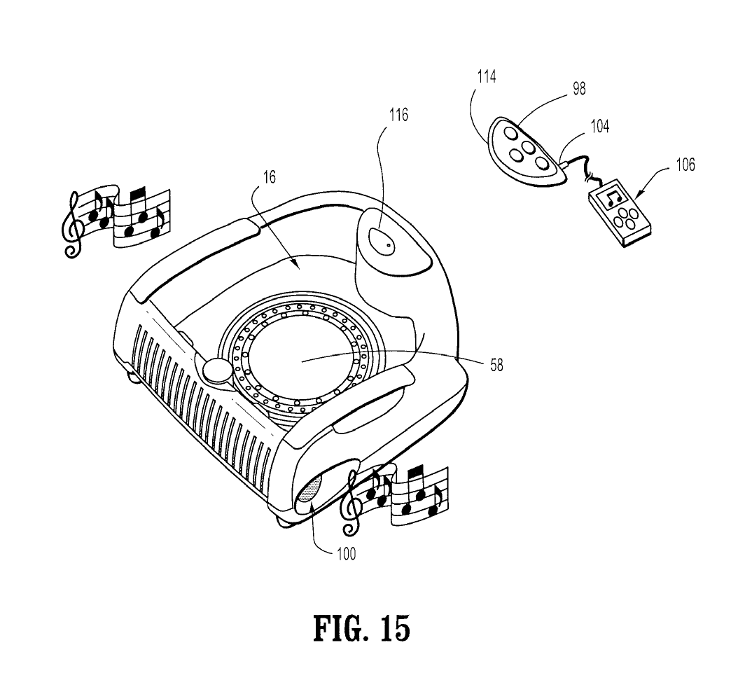

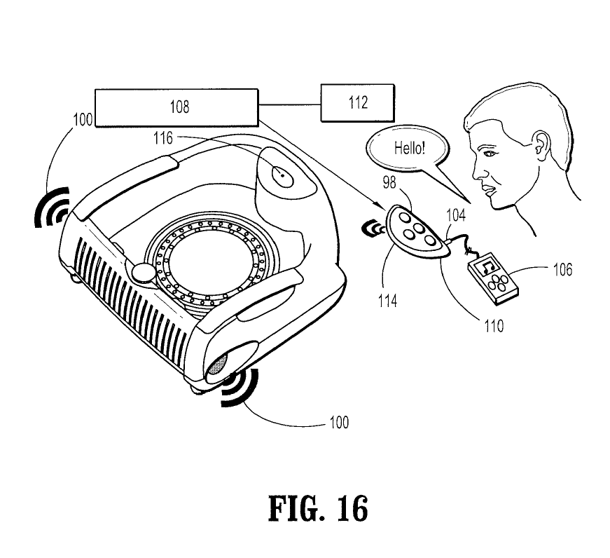

Referring now to FIGS. 15-16, in conjunction with FIGS. 3A-3B, the electronic components of foot massager apparatus 10 will be discussed. Foot massager apparatus 10 includes control panel 98 for inputting functional commands and/or for receiving output signals. One or more audio speakers such as speaker 100 may be mounted within any of the walls of housing 12. Control panel 98 may include an audio input jack such as an mp3 player input jack 104 for attaching and playing an mp3 file music or audio 106 for output through speakers 100. Control panel 98 may include a memory chip 108 for pre-stored audio files and it may include a voice input device such as a microphone 110 for inputting voice commands which are interpreted via computer logic, shown schematically as reference numeral 112, within, e.g., control panel, to control operation of foot massaging apparatus 10, or for creating voice recorder files to be played through speakers 100. Infra red transmitter and receiver units 114, 116 enable remote control of foot massager apparatus. In a “silent mode” of foot massager apparatus 10, the mist generator may be operating along with music form, e.g., the mp3 player 106.

The present disclosure having been thus described with particular reference to the preferred forms thereof, it will be obvious that various changes and modifications may be made therein without departing from the spirit of the present invention as defined herein.

What is claimed is:

1. A therapeutic apparatus, which comprises:
a body defining a chamber therein adapted to receive a user's feet;
a flexible membrane disposed within the chamber; and
a drive member associated within the flexible membrane for providing one of vibrating, percussive, repetitive or oscillating movement to the flexible membrane to provide a therapeutic effect on the user's feet.

2. The therapeutic apparatus according to claim 1 including a motor mounted within the body, the motor operatively coupled to the drive member and actuable to move the drive member to effect corresponding movement of the flexible membrane.

3. The therapeutic apparatus according to claim 2 wherein including an eccentric cam coupled to the motor and adapted for rotational movement about a drive axis to effect corresponding movement of the flexible membrane.

4. The therapeutic apparatus according to claim 3 including first and second eccentric cams coupled to the motor and disposed in spaced relation beneath the flexible membrane.

5. The therapeutic apparatus according to claim 3 wherein an associated eccentric cam is operatively coupled to a piston, the piston in operative engagement with the flexible membrane whereby rotation of the eccentric cam causes the piston to reciprocate to cause corresponding vibration of the membrane.

6. The therapeutic apparatus according to claim 5 including first and second eccentric cams coupled to the motor and having respective first and second pistons operatively coupled therewith, the pistons arranged in spaced relation beneath the flexible membrane.

7. The therapeutic apparatus according to claim 1 including at least one conduit and associated outlet to deliver fluid under pressure to the user's feet within the chamber.

8. The therapeutic apparatus according to claim 1 wherein the body includes at least one audio speaker for transmitting audio signals.

9. The therapeutic apparatus according to claim 1 wherein the body includes an audio input in communication with the at least one speaker.

10. The therapeutic apparatus according to claim 9 wherein the audio input is adapted for connection to an MP3 audio encoding format.

11. The therapeutic apparatus according to claim 8 including computer memory means for storing audio data.

12. The therapeutic apparatus according to claim 8 including voice input control and associated logic for receiving audio input signals from the user, and for transmitting signals through the at least one speaker.

13. The therapeutic apparatus according to claim 1 including voice input control and associated logic for controlling operation of at least the drive member.

14. The therapeutic apparatus according to claim 1 including a bubble emitter adjacent the flexible membrane for emitting bubbles toward the user's feet.

15. The therapeutic apparatus according to claim 14 wherein the bubble emitter is arranged to at least partially circumscribe the flexible membrane.

16. The therapeutic apparatus according to claim 1 including at least one splash guard mountable to the body, the at least one splash guard being adapted for sliding movement relative to the body.

17. The therapeutic apparatus according to claim 16 wherein the at least one splash guard includes one of a loofah pad or massaging roller.
